(19) United States
(12) Patent Application Publication
(10) Pub. No.: US 2020/0130160 A1
(43) Pub. Date: Apr. 30, 2020

(54) WORK ACCESSORY FOR STAPLER

(71) Applicant: TTI (MACAO COMMERCIAL OFFSHORE) LIMITED, Macau (MO)

(72) Inventors: Zachary P. Scott, Pendleton, SC (US); Ryan Altenburger, Greenville, SC (US)

(21) Appl. No.: 16/174,383

(22) Filed: Oct. 30, 2018

(51) Int. Cl. B25C 7/00

(52) U.S. Cl. CPC B25C 7/00; B25C 1/003

(57) ABSTRACT

A fastener driver includes a housing, a magazine coupled to the housing containing fasteners therein, and a nosepiece at least partially defining a fastener driving track into which fasteners from the magazine are individually received. A driver blade is movable from a retracted position toward an extended position during which a fastener in the fastener driving track is discharged from an opening in the nosepiece. A work accessory including a guide portion is configured to align an article with the nosepiece opening prior to attaching the article to a workpiece during a fastener driving operation, and a separate puller portion configured to apply a tensile force to an article to be attached to a workpiece during a fastener driving operation. The work accessory is adjustable relative to the nosepiece to selectively position the guide portion or the puller portion proximate the nosepiece opening.

### FIELD OF THE INVENTION

The present invention relates to power tools, and more particularly to powered fastener drivers.

### BACKGROUND OF THE INVENTION

Powered fastener drivers (e.g., nailers, stapler, etc.) are used to drive fasteners (e.g., nails, tacks, staples, etc.) into a workpiece. Sometimes, the fasteners are used to attach loose objects to the workpiece, such as wires or screens. When doing so, the user needs to hold the object in place or taut during a fastener driving operation.

### SUMMARY OF THE INVENTION

The present invention provides, in one aspect, a fastener driver including a housing, a magazine coupled to the housing containing fasteners therein, a nosepiece at least partially defining a fastener driving track into which fasteners from the magazine are individually received, a driver blade movable from a retracted position toward an extended position during which a fastener in the fastener driving track is discharged from an opening in the nosepiece, and a work accessory including a guide portion configured to align an article with the nosepiece opening prior to attaching the article to a workpiece during a fastener driving operation, and a separate puller portion configured to apply a tensile force to an article to be attached to a workpiece during a fastener driving operation. The work accessory is adjustable relative to the nosepiece to selectively position the guide portion or the puller portion proximate the nosepiece opening.

The present invention provides, in another aspect, a method of operating a fastener driver including providing a work accessory including a guide portion configured to align an article with a nosepiece opening of the fastener driver prior to attaching the article to a workpiece during a fastener driving operation, and a separate puller portion configured to apply a tensile force to an article to be attached to a workpiece during a fastener driving operation, attaching the work accessory to a nosepiece of the fastener driver in a first position where the guide portion is proximate the nosepiece opening, and adjusting the work accessory relative to the nosepiece from the first position to a second position where the puller portion is proximate the nosepiece opening.

Other features and aspects of the invention will become apparent by consideration of the following detailed description and accompanying drawings.

### BRIEF DESCRIPTION OF THE DRAWINGS

FIG. 1A is a perspective view of a powered fastener driver including a work accessory in accordance with an embodiment of the invention.

FIG. 1B is an enlarged partial cross-sectional view of the powered fastener driver of FIG. 1A through line 1B-1B in FIG. 1A.

FIG. 2 is a side perspective view of the work accessory of the powered fastener driver of FIG. 1A.

FIG. 3 is another side perspective view of the work accessory of the powered fastener driver of FIG. 1A.

FIG. 4 is another side perspective view of the work accessory of the powered fastener driver of FIG. 1A.

FIG. 5 is perspective view of the work accessory of FIG. 1A.

FIG. 6 is a perspective view of a nosepiece the powered fastener driver of FIG. 1A.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

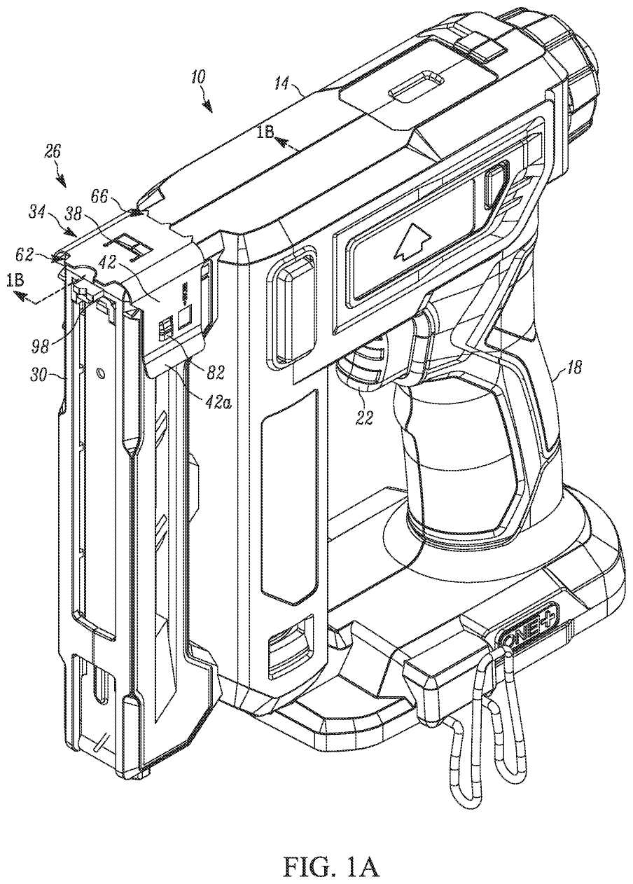

With reference to FIGS. 1A-1B, a powered fastener driver 10 for driving fasteners (e.g., nails, tacks, staples, etc.) into a workpiece is shown. The fastener driver 10 includes a housing 14, a handle 18 coupled to the housing 14, a driver blade 20, and a trigger 22 for operating the fastener driver 10. Additionally, the fastener driver 10 includes a nosepiece 26 that extends from the housing 14, and a magazine 30 for sequentially feeding fasteners (e.g., collated fasteners) into the nosepiece 26 prior to each fastener-driving operation. The nosepiece 26 at least partially defines a fastener driving track 28 into which fasteners from the magazine 30 are individually received. The driver blade 20 is movable from a retracted position toward an extended position during which the fastener in the fastener driving track 28 is discharged from an opening 98 in the nosepiece 26.

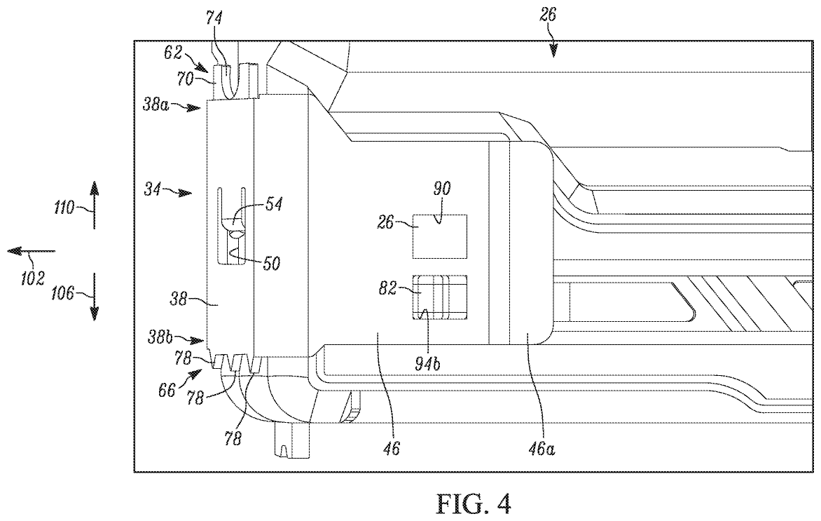

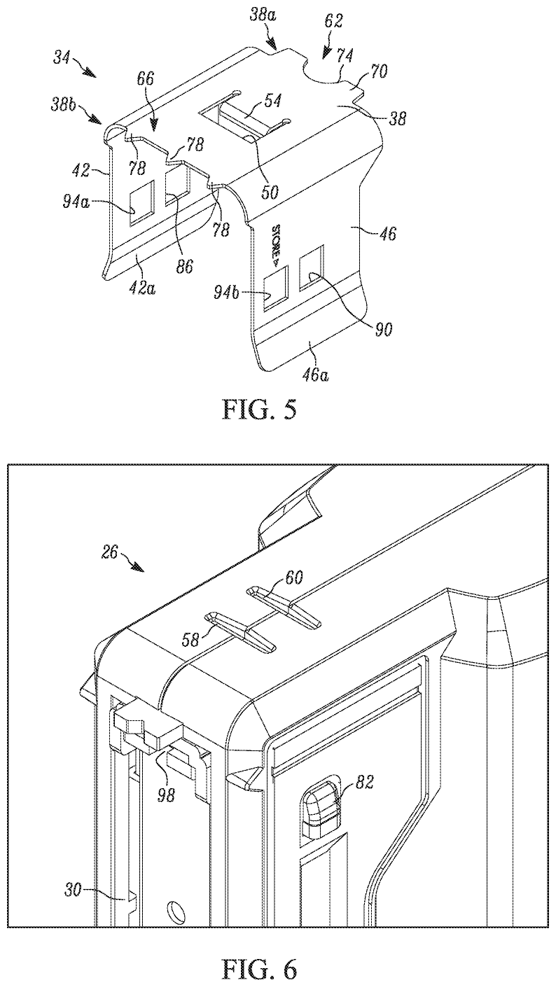

As shown in FIGS. 1-6, the fastener driver 10 includes a substantially U-shaped work accessory 34 removably coupled to the nosepiece 26. The accessory 34 includes a front face 38, a first arm 42 extending from one side of the front face 38, and a second arm 46 extending from an opposite side of the front face 38 that is substantially parallel to the first arm 42. The front face 38 further includes a central aperture 50 extending through the face 38, and a tab 54 positioned within the central aperture 50. The tab 54 is receivable within one of two notches 58, 60 (FIG. 6) in the nosepiece 26 when the accessory 34 is coupled to the nosepiece 26. As such, when either end of the front face 38 contacts a workpiece, the tab 54 prevents the accessory 34 from moving away from an opening 98 in the nosepiece 26 (FIG. 6). The first and second arms 42, 46 extend from opposite sides of the front face 38 and engage the nosepiece 26 in order to support the work accessory 34. As shown in FIG. 5, the first arm 42 and the second arm 46 are oriented perpendicular to the front face 38.

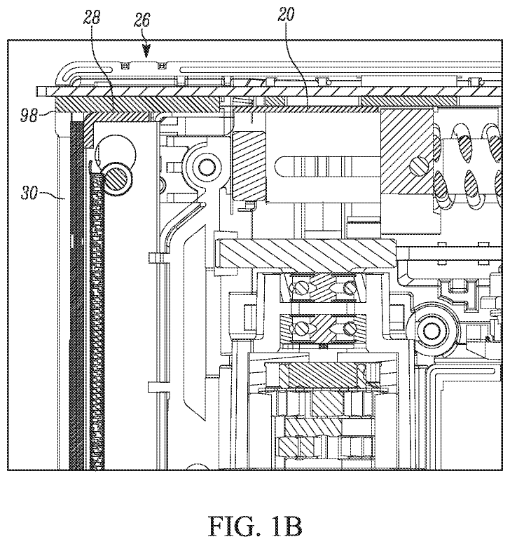

With reference to FIGS. 2-5, the accessory 34 includes a guide portion 62 on a first end 38a of the face 38 and a separate puller portion 66 on a second end 38b of the face 38, which is spaced apart from and opposite the first end 38a. The guide portion 62 includes a substantially rectangular flange 70 protruding from the first end 38a having an arcuate groove 74 defined therein. The groove 74 receives an article and/or object (e.g., a wire) and aligns the article with the nosepiece opening 98 prior to attaching the article to a workpiece during a fastener driving operation. The groove 74 enables a user to maintain the position of the wire during a fastener driving operation, therefore allowing one-handed operation. Depending upon a thickness of the wire, for example, the groove 74 may apply a clamping force on the wire in order to hold it on the workpiece while the wire is being fastened to the workpiece. In the illustrated embodiments, the groove 74 is arcuate-shaped. In alternative embodiments, the groove 74 may include alternative shapes.

The separate puller portion 66 of the accessory 34 includes a series of projections 78 protruding from the second end 38b of the face 38. The projections 78 engage and provide a tensile force to an article and/or object (e.g., a screen) on a workpiece in order to pull the object relative to the workpiece and maintain tension in the object while it is being fastened to the workpiece. Specifically, the projections 78 allow the accessory 34 to function as a screen puller during a fastener driving operation, therefore allowing one-handed operation. In the illustrated embodiment, the puller portion 66 includes three projections 78. However, alternative embodiments may include fewer or more projections 78 (e.g., two, four, etc.). Additionally, the puller portion 66 in the shown embodiments includes triangular-shaped projections 78. In alternative embodiments, the projections 78 may have alternate shapes.

In order to secure the work accessory 34 to the nosepiece 26, the work accessory 34 includes apertures on the first and second arms 42, 46 to selectively engage a detent 82 on the nosepiece 26. More specifically, the accessory 34 includes a first aperture 86 on the first arm 42 and a second aperture 90 on the second arm 46. In the illustrated embodiment of the fastener driver 10, the detent 82 is integrally formed with the nosepiece 26. Alternatively, the detent 82 may be a spring-loaded detent capable of retracting into the nosepiece 26 under pressure. The first and second apertures 86, 90 are identically sized and located in the same position (i.e., elevation) on the first and second arms 42, 46. In the shown embodiments, the nosepiece 26 includes a detent 82 on each side of the nosepiece 25, only one of which is shown in FIG. 6. However, in alternative embodiments, the nosepiece 26 may include only a single detent located on one side of the nosepiece 26. The detent 82 is located such that when the accessory 34 is positioned on the nosepiece 26, the first or second aperture 86, 90 aligns with and engages the detent 82 in order to secure the accessory 34 to the housing 14. As shown in FIG. 6, a front end of the detent 82 is arcuate in order to facilitate attachment of the accessory 34. A rear end of the detent 82 is perpendicular to the arms 42, 46, thereby providing a stop to prevent the accessory 34 from being removed unless the arms 42, 46 are intentionally deflected and pulled over the detent 82.

As shown in FIG. 5, the work accessory 34 additionally includes a third aperture 94 identically sized to the first and second apertures 86, 90, and positioned on either the first or second arm 42, 46. The third aperture 94 is spaced apart and horizontally aligned with either the first or second apertures 86, 90. Specifically, the third aperture 94 is positioned between the first or second aperture 86, 90 and the second end 38b of the front face 38. In the shown embodiments, the accessory 34 includes third apertures 94a, 94b on both the first arm 42 and the second arm 46. More specifically, the apertures 94a, 94b are identically sized and located in the same position on the first and second arms 42, 46, respectively. However, in alternative embodiments, the work accessory 34 may include only a single third aperture 94 on the first or second arm 42, 46. The third aperture 94 may engage and align with the detent 82 in order to secure the accessory 34 to the housing 14.

As illustrated in FIGS. 2-5, the work accessory 34 is adjustable relative to the nosepiece 26 to selectively position the guide portion 62 or the puller portion 66 proximate the nosepiece opening 98. With reference to FIG. 2, when the first aperture 86 engages the detent 82, the work accessory 34 is maintained in a first position. In the first position, the guide portion 62 is proximate the nosepiece opening 98 and the first end 38a of the front face 38 protrudes from the nosepiece 26. As such, the arcuate groove 74 protrudes from the nosepiece 26 below the nosepiece opening 98 and may engage a wire, or alternative object, to hold the wire in place on a workplace during a fastener driving operation.

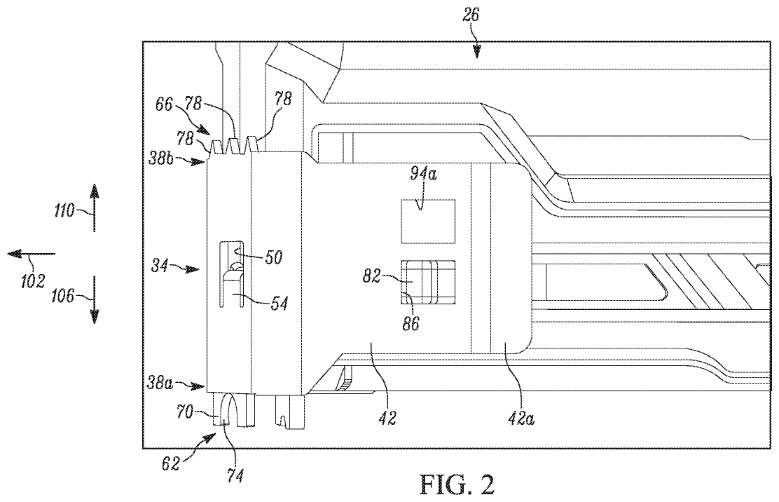

With reference to FIG. 3, when the second aperture 90 engages the detent 82, the work accessory 34 is maintained in a second position. In the second position, the puller portion 66 is proximate the nosepiece opening 98 and the second end 38b of the front face 38 protrudes from the nosepiece 26. As such, the projections 78 protrude from the nosepiece 26 below the nosepiece opening 98 and may engage a screen, or alternative object, to hold the screen in place and to maintain tension in the screen during a fastener driving operation.

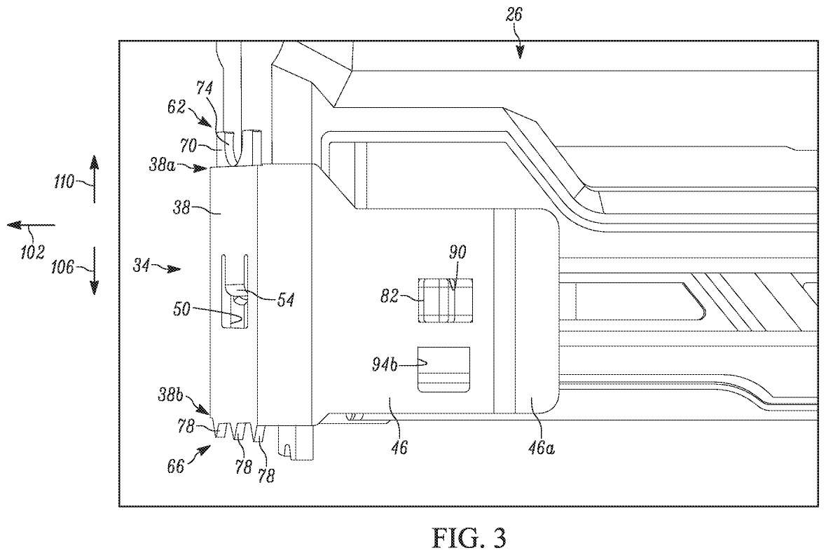

With reference to FIG. 4, the third aperture 94 may align with and engage the detent 82 in order to secure the accessory 34 to the housing 14 in a third, or storage, position. When in the third position, the accessory 34 has the same orientation as the second position (FIG. 3), where the second end 38b of the front face 38 is adjacent the nosepiece opening 98. However, unlike the second position, the tab 54 engages the second notch 60 and the third aperture 94b engages the detent 82. Therefore, neither the guide portion 62 nor the puller portion 66 protrudes from the nosepiece 26. The accessory 34 is fully positioned on the nosepiece 26, in a “storage” position, preventing the accessory 34 from aiding in a guiding or pulling operation.

In order to remove the accessory 34 from the nosepiece 26, a user must first remove the accessory 34 from the housing 14. More specifically, the user pulls oblique ends 42a, 46a of the arms 42, 46 outward away from the nosepiece 26, which permits the first aperture 86 to disengage the detent 82. This movement allows the user to slide the accessory 34 in a first direction 102, thereby disengaging the tab 54 from the notch 58 in the nosepiece 26. The user may then slide the accessory 34 in a second direction 106 (which is perpendicular to the first direction 102) below the nosepiece opening 98, thereby removing the accessory 34 from the nosepiece 26.

Furthermore, if a user needs to reattach the accessory 34 to the nosepiece 26 in an alternative position (e.g., reorient the accessory from the first position to the second position), the user must then rotate the accessory 34 180 degrees relative to the nosepiece 26. The user may then position the attachment 34 adjacent the nosepiece 26, pull the oblique ends 42a, 46a of the arms 42, 46 outward away from the nosepiece 26, and slide the attachment 34 a third direction 110 perpendicular to the first direction 102 and opposite the second direction 106. The user continues to slide the accessory 34 until the tab 54 engages the notch 58 and the second aperture 90 aligns with the detent 82. The user then releases the arms 42, 46, allowing the second aperture 90 to engage the detent 82.

Similarly, in order to reposition the accessory 34 from an active position (e.g., the second position, FIG. 3) to the storage position (FIG. 4), the user pulls the oblique ends 42a, 46a of the arms 42, 46 outward away from the nosepiece 26, permitting the second aperture 90 to disengage the detent 82. The user may then slide the accessory 34 in the third direction 110, permitting the third aperture 94 to align with the detent 82 and the tab 54 to engage the second notch 60. The user then releases the arms 42, 46, allowing the third aperture 94 to engage the detent 82.

Various features of the invention are set forth in the following claims.

What is claimed is:

1. A fastener driver comprising:
a housing;
a magazine coupled to the housing containing fasteners therein;
a nosepiece at least partially defining a fastener driving track into which fasteners from the magazine are individually received;
a driver blade movable from a retracted position toward an extended position during which a fastener in the fastener driving track is discharged from an opening in the nosepiece; and
a work accessory including a guide portion configured to align an article with the nosepiece opening prior to attaching the article to a workpiece during a fastener driving operation, and a separate puller portion configured to apply a tensile force to an article to be attached to a workpiece during a fastener driving operation,
wherein the work accessory is adjustable relative to the nosepiece to selectively position the guide portion or the puller portion proximate the nosepiece opening.

2. The fastener driver of claim 1, wherein the work accessory includes
a front face; and
first and second arms extending from opposite sides of the front face engageable with the housing to support the work accessory in a first position where the guide portion is proximate the nosepiece opening, or a second position where the puller portion is proximate the nosepiece opening.

3. The fastener driver of claim 2, wherein the first arm and the second arm are oriented substantially perpendicular to the front face.

4. The fastener driver of claim 2, wherein the work accessory includes a tab on the front face that is receivable within a notch in the nosepiece in each of the first and second positions.

5. The fastener driver of claim 2, wherein the guide portion includes an arcuate groove defined in a first end of the front face, and wherein the puller portion includes a plurality of projections extending from an opposite, second end of the front face.

6. The fastener driver of claim 5, wherein in the first position of the work accessory, the first end of the front face protrudes from the nosepiece, thereby locating the arcuate groove below the nosepiece opening.

7. The fastener driver of claim 6, wherein in the second position of the work accessory, the second end of the front face protrudes from the nosepiece, thereby locating the projections below the nosepiece opening.

8. The fastener driver of claim 7, wherein the work accessory is supportable on the housing in a third position where neither of the guide portion or the puller portion protrudes from the nosepiece.

9. The fastener driver of claim 8, further comprising:
a detent on one of the housing or the work accessory; and
first and second apertures in the other of the housing or the work accessory in which the detent is selectively received,
wherein the detent is received in the first aperture to maintain the work accessory in the first position, and wherein the detent is received in the second aperture to maintain the work accessory in the second position.

10. The fastener driver of claim 9, wherein the first and second apertures are located in the first and second arms, respectively, of the work accessory.

11. The fastener driver of claim 10, further comprising a third aperture located in one of the first or second arms, wherein the detent is received in the third aperture, with the work accessory having the same orientation as in the second position, to alternatively maintain the work accessory in the third position.

12. The fastener driver of claim 9, wherein the detent is movable relative to the work accessory to selectively remove the detent from either of the first and second apertures.

13. The fastener driver of claim 9, wherein both of the first and second arms of the work accessory are movable relative to the housing to selectively remove the detent from either of the first and second apertures.

14. The fastener driver of claim 5, wherein the arcuate groove is configured to engage a wire and the projections are configured to engage a screen.

15. A method of operating a fastener driver, the method comprising:
providing a work accessory including a guide portion configured to align an article with a nosepiece opening of the fastener driver prior to attaching the article to a workpiece during a fastener driving operation, and a separate puller portion configured to apply a tensile force to an article to be attached to a workpiece during a fastener driving operation;
attaching the work accessory to a nosepiece of the fastener driver in a first position where the guide portion is proximate the nosepiece opening; and
adjusting the work accessory relative to the nosepiece from the first position to a second position where the puller portion is proximate the nosepiece opening.

16. The method of claim 15, wherein adjusting the work accessory from the first position to the second position includes removing the work accessory from the housing, rotating the work accessory from the first position to the second position, and reattaching the work accessory to the housing.

17. The method of claim 16, further comprising adjusting the work accessory from the second position to a third position, in which the puller portion is above the nosepiece opening.

18. The method of claim 17, wherein adjusting the work accessory from the second position to the third position includes removing the work accessory from the housing, translating the work accessory from the second position to the third position, and reattaching the work accessory to the housing.

19. The method of claim 18, wherein removing the work accessory from the housing includes removing a tab on the work accessory from a notch in the nosepiece and concurrently, disengaging a detent on one of the housing or the work accessory from an aperture in the other of the housing or the work accessory.

20. The method of claim 19, wherein removing the work accessory from the housing includes resiliently deflecting one of the detent or the portion of the work accessory in which the aperture is defined to permit disengagement of the detent from the aperture.
